(19) United States
(12) Patent Application Publication
(10) Pub. No.: US 2020/0033505 A1
(43) Pub. Date: Jan. 30, 2020

(54) IMPROVED STRUCTURAL MODELLING

(71) Applicant: EQUINOR ENERGY AS, Stavanger (NO)

(72) Inventors: Erik NYRNES, Trondheim (NO); Jo SMISETH, Trondheim (NO); James ELGENES, Stavanger (NO)

(73) Assignee: EQUINOR ENERGY AS, Stavanger (NO)

(21) Appl. No.: 16/338,248

(22) PCT Filed: Sep. 25, 2017
(86) PCT No.: PCT/NO2017/050244

§ 371 Date: Mar. 29, 2019

(30) Foreign Application Priority Data
Sep. 30, 2016 (GB) 1616677.9

(51) Int. Cl. G01V 99/00; G01V 11/00; G01V 1/28

(52) U.S. Cl. CPC G01V 99/005; G01V 2210/667; G01V 1/282; G01V 11/002

(57) ABSTRACT

A method of calculating the likely positions of structures in a region of the earth's crust includes defining the region in the earth's crust; creating a first structural model of the region from seismic data with uncertainties and correlations; creating a second structural model of the region from measurements in a wellbore with uncertainties and correlations; creating a third structural model of the region from measurements in a volume around the wellbore measured from the wellbore with uncertainties and correlations; defining constraining equations for the first, second and third structural models; and using said constraining equations, calculating likely positions of structures in the region, and likely uncertainties and correlations relating to the positions.

### FIELD OF THE INVENTION

The invention relates to methods of calculating the likely positions of structures in the earth's crust.

The invention may include structural model updating by combining interpreted structural information from in-well deep azimuthal resistivity measurements or other in-well measurements surrounding the wellbore with interpreted seismic and well data with corresponding uncertainties using a statistical estimation approach.

### BACKGROUND OF THE INVENTION

UK Patent GB 2,467,687B describes a method of forming a geological model of a region of the Earth, which involves providing seismic data including seismic travel time uncertainty; providing a seismic velocity model of the region including velocity uncertainty; performing image ray tracing on the seismic data using the velocity model to determine the three dimensional positions of a plurality of points of the region; calculating three dimensional positional uncertainties of at least some of the points from the travel time uncertainty, the velocity uncertainty and uncertainty in ray propagation direction; and combining the determined positions with the calculated uncertainties to form a geological model.

UK Patent Application GB 2,486,877A describes a method of assessing the quality of subsurface position data and wellbore position data, comprising: providing a subsurface positional model of a region of the earth including the subsurface position data; providing a wellbore position model including the wellbore position data obtained from well-picks from wells in the region, each well-pick corresponding with a geological feature determined by a measurement taken in a well; identifying common points, each of which comprises a point in the subsurface positional model which corresponds to a well-pick of the wellbore position data; deriving an updated model of the region by adjusting at least one of the subsurface position data and the wellbore position data such that each common point has the most likely position in the subsurface positional model and the wellbore position data and has a local test value representing positional uncertainty; selecting some but not all of the common points and deriving a first test value from the local test values of the selected common points; providing a first positional error test limit for the selected common points; and comparing the first test value with the first test limit to provide a first assessment of data quality.

### SUMMARY OF THE INVENTION

The invention provides a method of calculating the likely positions of structures in a volume of the earth's crust, a method of performing a survey, a method of extracting hydrocarbons from a subsurface region of the earth, and a method of drilling a wellbore in a subsurface region of the earth, a computer readable medium and a programmed computer, as set out in the accompanying claims.

### BRIEF DESCRIPTION OF THE FIGURES

FIG. 1 describes an overall workflow of a method in accordance with the invention;

FIG. 2 shows a Bottom Hole Assembly (BHA) with EM-sensors seen from the side;

FIG. 3 shows the same situation as shown in FIG. 2 but where the BHA is seen from above in a horizontal/lateral plane (from the vertical axis);

FIG. 4 shows an example where the EM sensors measure the vertical distance to a geological feature;

FIG. 5 shows the definition of well picks and formation structures;

FIG. 6 shows a Situation 1, and is a Seismic data section where we have drilled a well path shown by a solid white line;

FIG. 7 shows a Situation 2, and is a Seismic data section where we have drilled a well path shown by a solid white line;

FIG. 8 shows two uncertainty maps which represent the depth uncertainty for the top of the hydrocarbon reservoir;

FIG. 9 shows an example of a covariance matrix of two points, a well pick and a seismic point; and

FIG. 10 shows an example of a covariance matrix of two statistically independent points

### DESCRIPTION OF PREFERRED EMBODIMENTS

Preferred embodiments will now be described, by way of example only, with reference to the accompanying drawings.

Each feature disclosed or illustrated in the present specification may be incorporated in the invention, whether alone or in any appropriate combination with any other feature disclosed or illustrated herein.

The starting point for the described embodiments is that the position of at least one point in the volume of the subsurface around the wellbore is measured by different types of instruments placed along the bottom hole assembly (BHA) in the wellbore. Examples of such measurements are deep azimuthal resistivity measurements, ahead of bit resistivity measurements, acoustic measurements, and neutron density measurements. These instruments can measure contrasts in for example electric resistivity which can correspond to for instance oil-water contacts, the top of hydrocarbon reservoirs, and interfaces between different rock types. Moreover, the positions of formation structures in a subsurface area covering the wellbore are measured via seismic surveys. Formation structures penetrated by the wellbore are measured and interpreted, and may also have been measured for other wellbores in the subsurface area. These measurements are called “well picks”.

Therefore at least three type of measurement may be used, namely in-well measurements around the wellbore, out-of-well seismic measurements, and well picks.

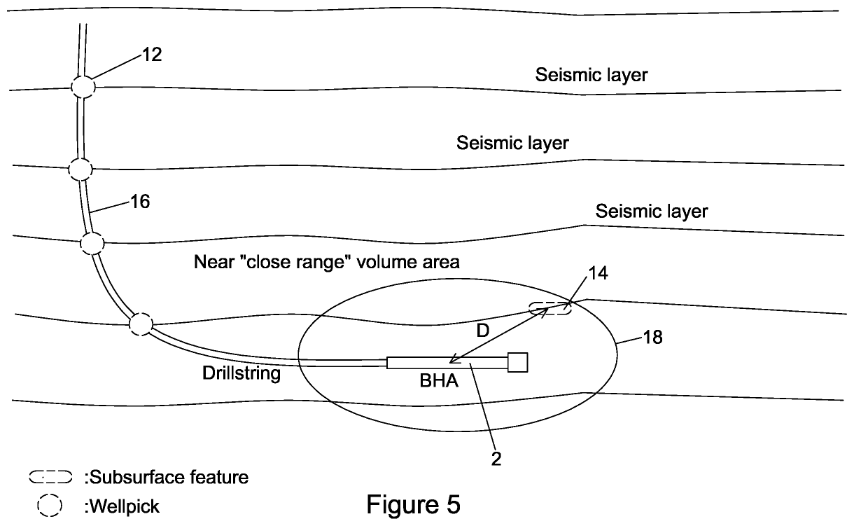

Well picks, subsurface features and near wellbore volume measurements are defined in FIG. 5. A well pick is identified by the log when the BHA is penetrating the layer. The absolute position of the borehole (measured by the Measurement While Drilling (MWD) directional survey instrument) is assigned to the well pick. A subsurface feature is a structure which could be e.g. a geological formation, fault, structural surface or fluid contact or any interfacing surface or line between two consecutive seismic layers, is identified within a limited volume around the BHA in the wellbore. The direction and distance from the BHA to the subsurface feature are calculated from the near volume measurements performed by the various sensors in the BHA.

An acoustic velocity model describes the velocity of the seismic wave propagation within the subsurface which can be used as a scaling factor in order to take time data derived from seismic data and scale it into depth.

Assume that we have an acoustic velocity model available for the formation structures in the subsurface area. The velocities can be obtained using the relationship between time and depth (V=D/T) with the depth (D) as the geological well observations and the time (T) as the seismic interpretation. Assume that we have a seismic depth model available. A depth model describes the end results after converting time derived subsurface seismic data using an acoustic velocity model to the estimated depth of subsurface seismic data. A depth model is a collection of the coordinates and corresponding uncertainties of the subsurface structures. Assume that we also have available the measurements in the volume around the wellbore along with uncertainties of these measurements, and the well picks with uncertainties in three spatial dimensions. The uncertainties (statistical properties) of every spatial point in the depth model are represented by a covariance matrix. The covariance matrix consists of variances on the diagonal elements, and covariances on the off-diagonal elements. Covariances describe the statistical dependencies between coordinates. Similarly, the statistical dependencies between coordinates of spatial points (being a seismic point, a well pick, or a point measured in the volume around the wellbore) are expressed in terms of covariances of a joint covariance matrix. FIG. 9 shows an example of such a joint covariance matrix for two spatial points, in this case a well pick and a seismic point.

We first make some comments relating to the directional surveys of the wellbore. The basic measurements are the length along the wellbore from a reference point at the surface, and the two directional components called inclination and azimuth. The inclination is defined as the deflection of the wellbore axis with respect to the gravity field vector, while the azimuth is the direction in the horizon plane with respect to north. A common method for measuring the direction of the wellbore is to use a magnetic MWD survey instrument. Such an instrument consists of accelerometers and magnetometers which measure components of the Earth's gravity field and the Earth's magnetic field, respectively. The accelerometer measurements are used to determine the inclination of the wellbore, whereas the azimuth is determined from the magnetometer measurements. The position of the wellbore is a function of inclination, azimuth and the length of the drillstring from a surface reference point.

A novel aspect of embodiments is to update the depth model and the corresponding full covariance matrix with interpreted structural information up to 3D directional and distance measurements (and corresponding statistical properties) in the near volume around the wellbore, such as resistivity measurements. A measurement of a point in the near volume around the wellbore with sensors in the BHA is illustrated in FIG. 5. The uncertainties of near volume measurements can be stipulated prior to drilling based on sensor specific error models, or estimated as a by-product of the least squares estimation approach.

We start by identifying one or more points of measurement in the near volume around the wellbore which correspond to one or more subsurface features in the depth model. The points can for example be interpreted from an image reflecting the electric resistivity of the volume surrounding the probing device. These points may be assigned with up to three dimensional spatial coordinates. The coordinates of such a point are estimated by using the survey of the wellbore as a reference combined with the resistivity model to find the relative distance and direction from a well reference point (determined from the above-mentioned survey of the wellbore) to the interpreted point (corresponding with a subsurface feature). Each such point must be assigned with statistical properties, reflected in a point covariance matrix. This covariance matrix may be obtained by applying the law of covariance propagation on the three available types of positional information; the survey of the wellbore, the resistivity model, and the interpretation of the subsurface feature from the resistivity model. The measurements in the volume around the wellbore could be a collection of points which resembles a line or surface. In such a collection of points each point would potentially be correlated with all the other points. The correlation between points can be modeled by a joint covariance matrix for all consecutive points in the near wellbore volume. This joint covariance matrix may be obtained by applying the law of covariance propagation on the three available types of positional information described above.

All the available positional information (such as coordinates of well picks, coordinates of seismic points, coordinates of wellbore reference points and near wellbore volume measurements) may be mutually statistically dependent. Such types of correlations can be expressed by covariance components in a joint covariance matrix. This joint prior covariance matrix may be obtained by applying the law of covariance propagation on available types of positional information.

The measured points in the near volume around the wellbore and well picks can be tied to the seismic depth model through constraining equations. A constraining equation expresses mathematically how the coordinates of points are related, e.g. that the coordinates of a point measured from the wellbore (being either a well-pick or a near volume measurement) are equal to or differ with a certain defined distance from the corresponding point in the seismic depth model. The most probable positions of all the points in the depth model with corresponding statistical properties (which may be expressed by a covariance matrix) are calculated based on this redundant measurement information (using for instance a least squares estimation approach such as the one described in the patent EP1306694 by Torgeir Torkildsen). A least squares estimation approach may be applied for this purpose. In such a way the prior positional information is adjusted correctly based on its prior positional statistical properties.

The procedure of tying points measured from the wellbore with the seismic depth model may be summarized by the following steps:
1. Gather prior positional information including prior covariance matrices
2. Define constraining equations to tie together positional information
3. Adjust the positional information and the joint covariance matrix based on introducing constraining equations and the method of least squares

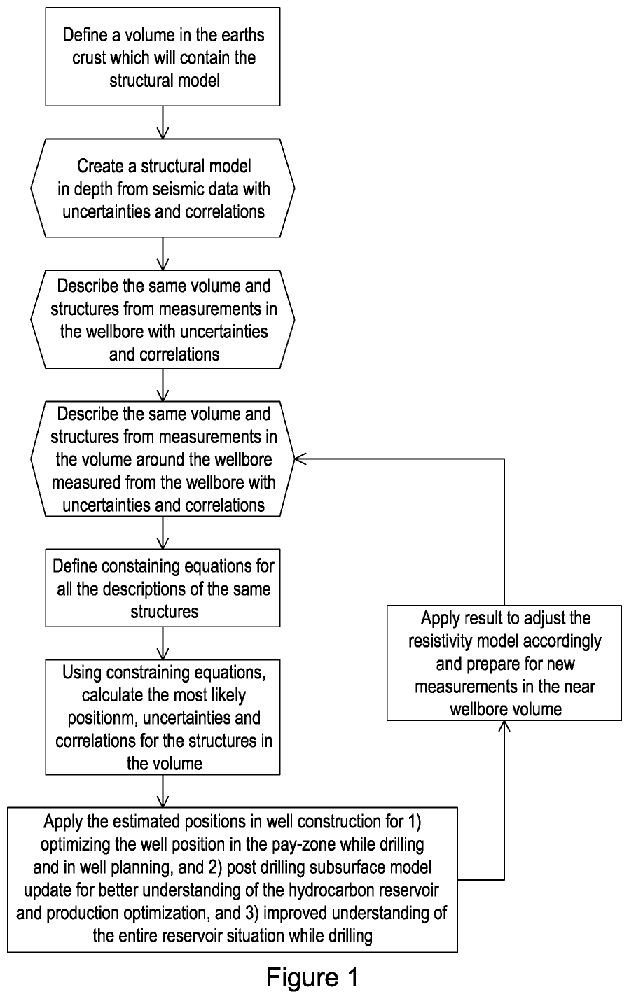

The result is a depth model with statistical properties which are correctly adjusted based on all available positional information with corresponding statistical properties. This result may be applied to adjust the resistivity model accordingly and prepare for new measurements in the near wellbore volume. The overall workflow describing the preferred embodiment is shown in FIG. 1. The novel element of including measurements with corresponding uncertainties and correlations from the volume surrounding the wellbore measured from the wellbore with deep azimuthal resistivity measurements as an example are described in the figures below.

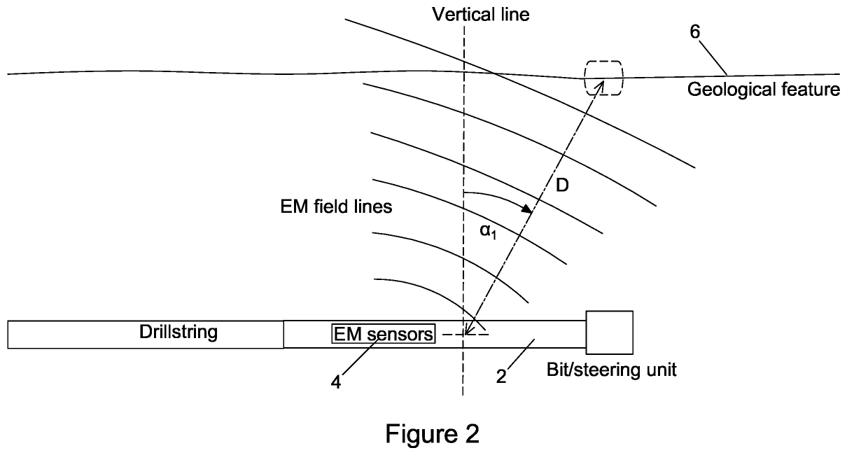

FIG. 2 shows a Bottom Hole Assembly (BHA) 2 with EM-sensors 4 seen from the side. When the distance is measured from several discrete positions (survey points) along the wellpath the position of the geological feature 6 can be calculated using e.g. trilateration techniques. When directional measurements are available in addition to distances, 3D triangulation adjustment techniques can be applied. The figure shows an example where the EM sensor package 4 measures the 3D distance and 3D direction to a certain geological feature 6 (horizon surface etc.). From these measurements the 3D position of the geological feature 6 is determined. The 3D position of the geological feature 6 can be calculated with respect to a local BHA-based coordinate system, or represented by North, East and True Vertical Depth (TVD) coordinates.

Based on accelerometer and magnetometer sensors in the Measurement While Drilling (MWD) survey package it is possible to determine the orientation of the BHA (including the EM sensor package) with respect to a global North, East and TVD coordinate system. It will then be possible to transform between coordinates in the local BHA-based coordinate system and the global North, East and TVD coordinate system.

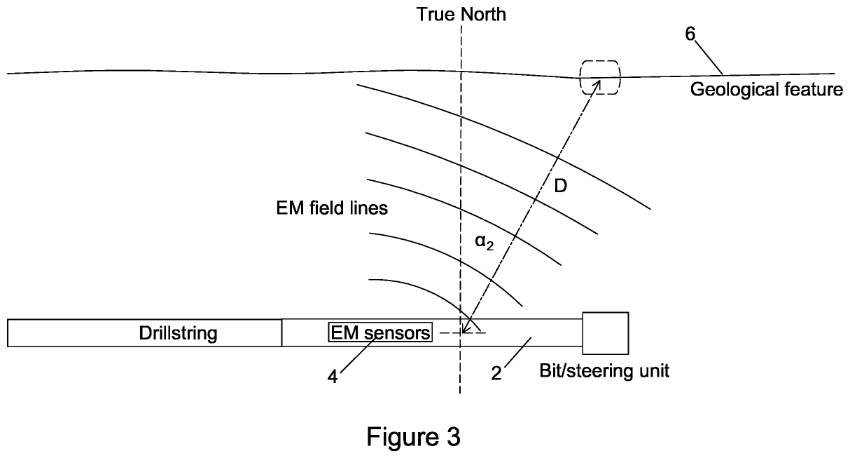

FIG. 3 shows the same situation as shown in FIG. 2 but where the BHA 2 is seen in a horizontal/lateral plane (from the vertical axis).

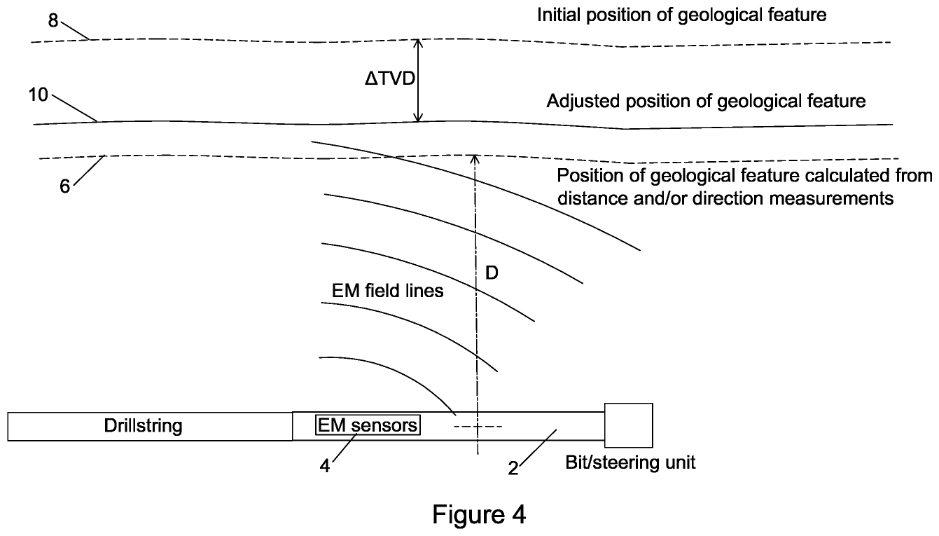

FIG. 4 shows an example where the EM sensors 4 measure the vertical distance to a geological feature 6. The same geological feature (shown by the dashed line 8) is also determined based on seismic data only 8. This surface has high uncertainty due to the relatively poor seismic accuracy. The measured distance (D) ties together the vertical position of the BHA 2 and the vertical position of the geological feature 6. The accuracy of the measured distance defines the stringency of this constraint. Because the position of the BHA 2 has significantly better accuracy than the initial position of the geological feature 8 (determined by using the prior time and velocity input to the model), the adjusted vertical position of the surface (solid line 10) will end up closer to the initial vertical position of the geological feature 6 that was originally measured by the EM tool 4. The result is an adjusted geological surface with improved TVD accuracy.

Relevant software for this application are
Software for processing of resistivity data and presenting resistivity images for interpretation. Examples are AziTrak™ deep azimuthal resistivity measurement tool from Baker Hughes which allows for geo-steering and software for electromagnetic look-ahead EMLA developed by Schlumberger and Statoil
Geo-modeling software such as Landmark DecisionSpace Desktop and Petrel from Schlumberger
Seismic depth conversion tools such as Paradigm Explorer, COHIBA from Roxar, and EasyDC.
Landmark Compass software tool for well path positional uncertainty estimation
PinPoint (Statoil internal)

Applications of the methods described will now be described.

The updated structural model can be applied to optimize the position of the drill bit in the pay-zone (i.e. the region producing hydrocarbons) in a while-drilling situation. This model can by updated in real time by using the new data collected during drilling. The model can be updated by recursive (e.g. by the method of least squares) estimation for instance to save computation time. If the model is updated by recursive estimation, the contributions from the new measurements to the prior positions of the structures are calculated using e.g. Kalman Filtering or similar recursive estimation approaches. Moreover, the updated model may be applied in the well planning phase for new wells in the region to provide more optimal well path placements for these. Finally, the updated model may be applied post drilling for creating a better understanding of the reservoir situation around the well, to optimize production in the production phase.

FIG. 5 shows the definition of well picks 12, subsurface features 14 and near wellbore volume measurements. A well pick 12 is identified by the log when the BHA 2 is penetrating a layer. The absolute position of the borehole 16 (measured by the MWD directional survey instrument) is assigned to the well pick 12. A subsurface feature 14 is identified within a limited volume 18 around the BHA 2 in the wellbore 16. The direction and distance from the BHA 2 to the subsurface feature 14 are calculated from the near volume measurements performed by the various sensors in the BHA 2, for instance one or more resistivity sensors distributed along the BHA 2.

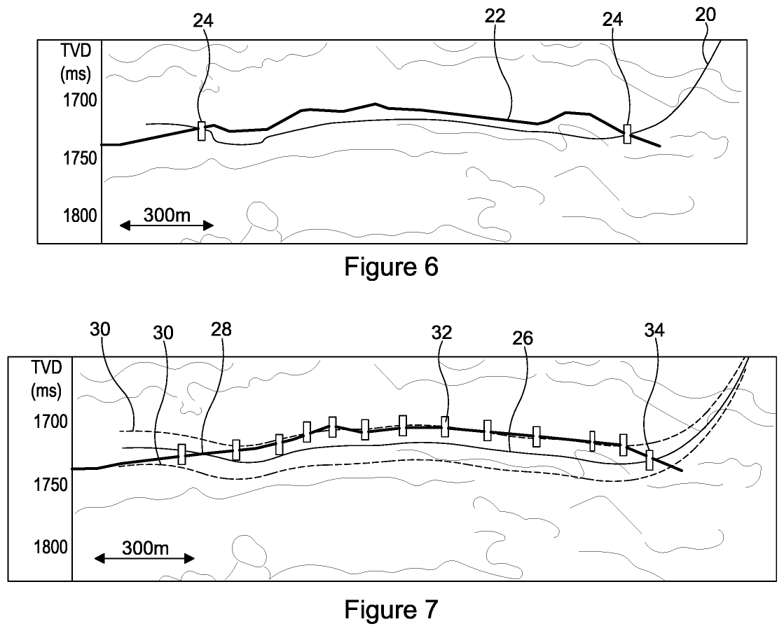

FIG. 6 shows a Situation 1, and is a Seismic data section where we have drilled a well path 20 shown by a solid white line. The black line is a seismic horizon 22 which represents the seismic interpretation of the top of a hydrocarbon reservoir. We have not utilized any electric resistivity measurements in this situation but we have calibrated the seismic horizon to the drilled well picks, represented by the black markers 24. In this example, we have a lot of uncertainty regarding the geometry and topography of the top of the hydrocarbon reservoir (black line) between the well pick markers 24. The depth of the top of the reservoir is uncertain and we risk missing out on potential volumes if we need to sidetrack (drill to the side of the well path) or drill another well in the area.

FIG. 7: shows a Situation 2, and is a Seismic section where we have drilled a well path 26 shown by a white line and a seismic interpretation 28 shown by a black line. The white dotted lines 30 represent the theoretical depth range of penetration for EM deep resistivity measurements (+−10 m). The white markers 32 represent the detection of the top reservoir from the deep resistivity measurements. The black markers 34 represent the drilled well picks. We have calibrated the seismic horizon 28 to the white markers 32 and the black markers 34. The markers, interpretation and the well survey all have an associated uncertainty which are algebraically combined to give an up to date overall position and uncertainty of the top reservoir surface. In this example, we have an updated top reservoir depth surface which can be used to optimize the position of a well plan in a drilling situation and can also be used post drilling in order to constrain volumes and optimize production.

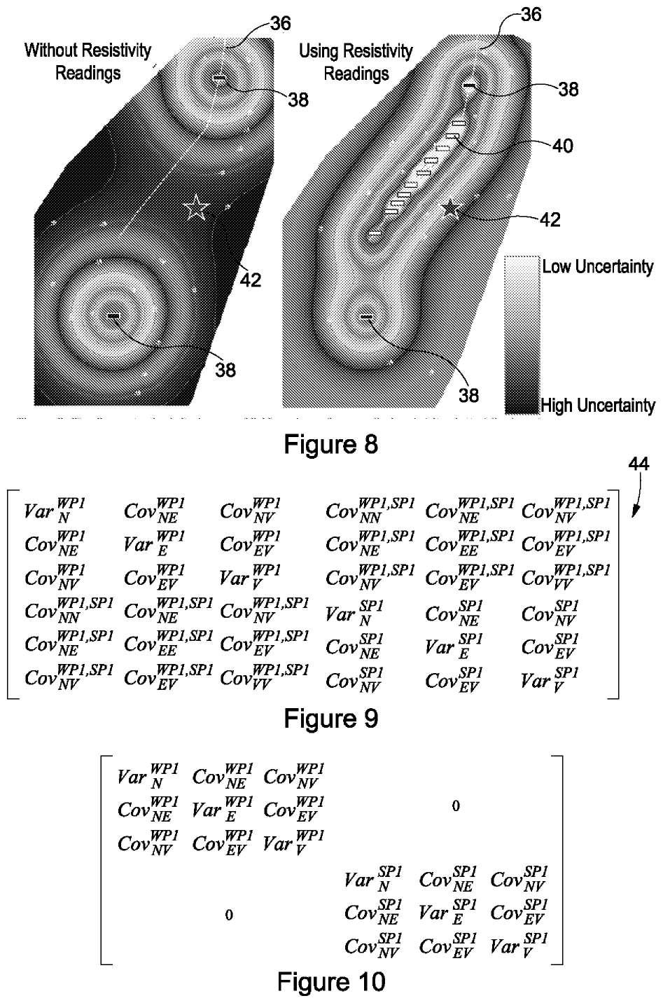

FIG. 8 shows two uncertainty maps which represent the depth uncertainty for the top of the hydrocarbon reservoir. A drilled well is represented by a white dotted line 36. The black markers 38 represent geological well observations for the top of the hydrocarbon reservoir and the white markers 40 represent deep resistivity well observations for the top of the hydrocarbon reservoir. The figure to the left can be directly comparable to the situation shown in FIG. 6 which has not used the deep resistivity readings. Imagine we have to drill a new well at a reservoir target represented by the black star 42. Without using any deep resistivity observations, we would have an uncertainty of +−20 m at 2 standard deviations.

The figure to the right is now integrating both the drilled geological well observations and the deep resistivity well observations. This corresponds to the situation shown in FIG. 7. Now we have an optimized surface which will reduce the uncertainties to 12 m at 2 standard deviations at the black star target location 42.

FIG. 9 shows an example of a joint covariance matrix 44 of two points in 3D, a well pick (represented by WP1 in the matrix) and a seismic point (represented by SP1 in the matrix). The statistical dependencies between the coordinates of the well pick and the coordinates of the seismic point are described by the 3 times 3 matrices in the upper right and lower left corners, respectively. The 3 times 3 matrices in the upper left and lower right corner are the covariance matrices of the well pick and seismic point respectively. The diagonal elements of the joint covariance matrix are the variances of the coordinates of the well pick and seismic point.

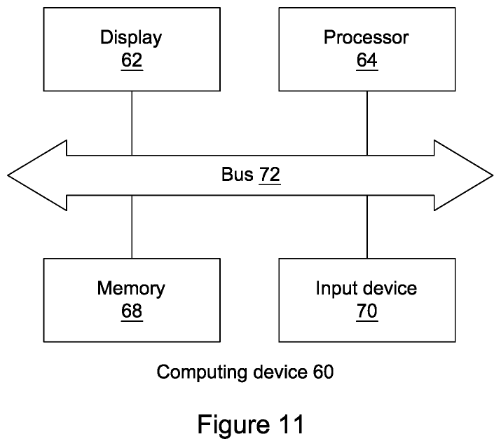

FIG. 10 shows an example where the well pick and seismic point are statistically independent. This is expressed through zero covariances between the coordinates of the well pick and the coordinates of the seismic point.

FIG. 11 shows a computing device 60, which may for example be a personal computer (PC), on which methods described herein can be carried out. The computing device 60 comprises a display 62 for displaying information, a processor 64, a memory 68 and an input device 70 for allowing information to be input to the computing device. The input device 70 may for example include a connection to other computers or to computer readable media, and may also include a mouse or keyboard for allowing a user to enter information. These elements are connected by a bus 72 via which information is exchanged between the components.

It should be appreciated that any of the methods described herein may also include the step of acquiring data, including seismic and/or electromagnetic data, which may then be processed in accordance with the method.

The methods described herein of calculating the likely positions of structures in a region of the earth's crust may be used in a method of performing a survey, in a method of extracting hydrocarbons from a subsurface region of the earth, and in a method of drilling a wellbore in a subsurface region of the earth. Instructions for performing said methods described herein may be stored on a computer readable medium, and said methods may be performed on a programmed computer.

1. A method of calculating the likely positions of structures in a region of the earth's crust, said method comprising:
defining said region in the earth's crust;
creating a first structural model of said region from seismic data with uncertainties and correlations;
creating a second structural model of said region from measurements in at least one wellbore with uncertainties and correlations;
creating a third structural model of said region from measurements in a volume around said wellbore measured from the wellbore with uncertainties and correlations;
defining constraining equations for said first, second and third structural models; and
using said constraining equations, calculating likely positions of structures in said region, and likely uncertainties and correlations relating to said positions.

2. The method as claimed in claim 1, wherein said measurements in said volume around said wellbore comprise deep azimuthal resistivity measurements.

3. The method as claimed in claim 1, wherein said measurements in said volume around said wellbore comprise ahead of bit resistivity measurements.

4. The method as claimed in claim 1, wherein said measurements in said volume around said wellbore comprise in-well acoustic measurements.

5. The method as claimed in claim 1, wherein said measurements in said volume around said wellbore comprise neutron density measurements.

6. The method as claimed in claim 1, which comprises performing a seismic survey of a subsurface region overlapping said region.

7. The method as claimed in claim 6, which comprises identifying at least some of said structures in both said seismic survey and said measurements in said volume around said wellbore and using said structures to define said constraining equations.

8. The method as claimed in claim 6, which further comprises creating an acoustic velocity model for said subsurface region.

9. The method as claimed in claim 8, wherein said acoustic velocity model is obtained by comparing seismic measurements with position measurements from drilled wells in said subsurface region.

10. The method as claimed in claim 8, which further comprises combining seismic structural interpretations of said structures in the time domain with said acoustic velocity model, said measurements in said volume around said wellbore, and said measurements in said wellbore.

11. The method as claimed in claim 10, which further comprises using said combining step to estimate a depth model of said structures with a full covariance matrix in three spatial dimensions.

12. The method as claimed in claim 11, wherein:
spatial points in said depth model are each represented by three variables in said covariance matrix;
acoustic velocities in said acoustic velocity model are each represented by a variable in said covariance matrix; and
said covariance matrix describes uncertainty between said variables and correlations between said variables.

13. The method as claimed in claim 11, wherein interpreted points corresponding with said structures, and “well picks” from said measurements in said wellbore, and said measurements from outside said wellbore are tied through constraining equations to find the most likely positions and corresponding statistical properties in said depth model.

14. The method as claimed in claim 1, which further comprises:
providing a seismic depth model; and
representing the statistical properties of each spatial point in said depth model by elements of a covariance matrix.

15. The method as claimed in claim 14, which further comprises:
expressing by means of covariance components in a joint covariance matrix statistical dependencies between at least the following:
coordinates of at least one well pick;
coordinates of at least one seismic point; and
coordinates of at least one point measured in said volume around said wellbore.

16. The method as claimed in claim 14, wherein said depth model is obtained by combining an acoustic velocity model with seismic data interpreted in the time domain.

17. The method as claimed in claim 14, which further comprises updating said depth model and said covariance matrix with interpreted structural information from said measurements in said volume around said wellbore.

18. The method as claimed in claim 14, wherein said spatial points are obtained from said first, second and third structural models.

19. The method as claimed in claim 14, which further comprises:
creating a resistivity model of the resistivity in said region of the earth's crust; and
using said depth model to adjust said resistivity model.

20. The method as claimed in claim 1, wherein said measurements in a volume around said wellbore are measurements of the earth's crust outside of said at least one wellbore.

21. The method as claimed in claim 1, wherein said constraining equations express how the coordinates of a point in one of said first, second or third structural models differ from the corresponding point in another of said first, second or third structural models.

22. A method of performing a survey comprising:
conducting a seismic survey to obtain seismic data with uncertainties and correlations;
taking measurements in a wellbore with uncertainties and correlations;
taking measurements in a volume around said wellbore measured from the wellbore with uncertainties and correlations; and
using said seismic data and measurements, performing a method of calculating the likely positions of structures in a volume of the earth's crust as claimed in claim 1.

23. The method of performing a survey as claimed in claim 22, wherein said step of taking measurements in a volume around said wellbore includes using one or more measurement instruments located within said wellbore.

24. A method of extracting hydrocarbons from a subsurface region of the earth, said method comprising:
drilling a wellbore;
performing a survey as claimed in claim 22;
using the results of said survey to locate the presence of hydrocarbons in said subsurface region of the earth; and
extracting said hydrocarbons via said wellbore.

25. A method of drilling a wellbore in a subsurface region of the earth, said method comprising:
commencing drilling of a wellbore;
performing a survey as claimed in claim 22;
using the results of said survey to determine the desired position of the wellbore in said subsurface region of the earth; and
continuing drilling of said wellbore in accordance with said desired position.

26. The method of drilling a wellbore as claimed in claim 25, wherein said likely positions of structures in said region are updated in real time using new data collected during drilling.

27. The method of drilling a wellbore as claimed in claim 26, wherein said likely positions of structures in said region are updated by recursive estimation.

28. The method of drilling a wellbore as claimed in claim 27, wherein contributions from new measurements to the prior positions of said structures are calculated using recursive estimation approaches.

29. The method of drilling a wellbore as claimed in claim 28, wherein contributions from new measurements to the prior positions of said structures are calculated using Kalman filtering.

30. A non-transitory computer readable medium carrying instructions for performing the method of claim 1.

31. A computer programmed to carry out the method of claim 1.
